(19) United States
(12) Patent Application Publication
(10) Pub. No.: US 2009/0267445 A1
(43) Pub. Date: Oct. 29, 2009

(54) MICRO ROCKING DEVICE AND METHOD FOR MANUFACTURING THE SAME

(75) Inventors: Yoshihiro MIZUNO, Kawasaki (JP); Norinao Kouma, Kawasaki (JP); Hisao Okuda, Kawasaki (JP); Hiromitsu Soneda, Kawasaki-shi (JP); Tsuyoshi Matsumoto, Kawasaki (JP); Osamu Tsuboi, Kawasaki (JP); Ippei Sawaki, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED, Kawasaki (JP)

(21) Appl. No.: 12/249,677

(22) Filed: Oct. 10, 2008

(30) Foreign Application Priority Data
Nov. 2, 2007 (JP) 2007-286037

(51) Int. Cl. H02N 11/00; B44C 1/22

(52) U.S. Cl. 310/300; 216/41

(57) ABSTRACT

A micro rocking device includes a frame, a rocking portion, a torsion connecting portion, and a second comb-like electrode, the rocking portion including a first comb-like electrode. The torsion connecting portion connects the frame and the rocking portion. The torsion connecting portion defines the axis of rotational displacement of the rocking portion. The second comb-like electrode attracts the first comb-like electrode and rotationally displaces the rocking portion. The first comb-like electrode has a plurality of first parallel electrode teeth which extend in the direction of the axis and which are spaced from each other in a direction crossing the extension direction. The second comb-like electrode has a plurality of second parallel electrode teeth which extend in the direction of the axis and which are spaced from each other in a direction crossing the extension direction.

### CROSS-REFERENCE TO RELATED APPLICATIONS

This application is related to and claims priority to Japanese patent application no. 2007-286037 filed on. Nov. 2, 2007 in the Japan Patent Office, and the entire disclosure of which is incorporated by reference herein.

### BACKGROUND

1. Field

The present invention relates to a micro rocking device having a micro rocking portion, such as a micro mirror device, an acceleration sensor, an angular velocity sensor, or an oscillating device, and a method for manufacturing the same.

2. Description of the Related Art

In various technical fields, attempts have recently been made to apply devices each having a micro structure formed by a micro machining technique. Japanese Laid-Open Patent Publication Nos. 2003-19700, 2004-341364, and 2006-72252 disclose micro rocking devices. Examples of such devices include micro rocking devices each having a micro rocking portion, such as a micro mirror device, an angular velocity sensor, an acceleration sensor, and the like. The micro mirror device is used as a device having a light reflecting function, for example, in the field of optical disk technology and optical communication technology. The angular velocity sensor and the acceleration sensor are used, for example, in applications to an image stabilizing function of a video camera and a camera cell-phone, a car navigation system, an air-bag open timing system, and attitude control systems of a vehicle, a robot, and the like.

### SUMMARY

According to an aspect of an embodiment, a micro rocking device includes a frame, a rocking portion, a torsion connecting portion, and a second comb-like electrode, the rocking portion including a first comb-like electrode. The torsion connecting portion connects the frame and the rocking portion. The torsion connecting portion defines the center axis of rotational displacement of the rocking portion. The second comb-like electrode attracts the first comb-like electrode to rotationally displace the rocking portion. The first comb-like electrode has a plurality of first parallel electrode teeth which extend in the direction of the axis and which are spaced from each other in a direction crossing the extension direction. The second comb-like electrode has a plurality of second parallel electrode teeth which extend in the direction of the axis and which are spaced from each other in a direction crossing the extension direction. Each of the second electrode teeth has a first side surface on the axis side and a second side surface opposite to the first side surface. The second side surface has a taper region on the side opposite to the first electrode teeth, the taper region being inclined closer to the axis in a direction away from the first electrode teeth.

### BRIEF DESCRIPTION OF THE DRAWINGS

FIG. 1 is a plan view of a micro rocking device according to a first embodiment;

FIG. 2 is a partially omitted plan view of the micro rocking device shown in FIG. 1;

FIG. 3 is a sectional view taken along line III-III of FIG. 1;

FIG. 4 is a sectional view taken along line IV-IV of FIG. 1;

FIG. 5 is a sectional view taken along line V-V of FIG. 1;

FIGS. 6A to 6D are drawings showing steps of a method for manufacturing the micro rocking device shown in FIG. 1;

FIGS. 7A to 7D are drawings showing steps subsequent to the steps shown in FIG. 6A to 6D;

FIG. 8 is a drawing showing a form of a electrode teeth mask region;

FIG. 9 is a sectional view of the micro rocking device during driving, taken along line III-III of FIG. 1;

FIG. 10 is a sectional view of a micro rocking device according to a second embodiment;

FIG. 11 is another sectional view of the micro rocking device according to the second embodiment;

FIG. 12 is a sectional view of the micro rocking device shown in FIG. 10 during driving;

FIGS. 13A to 13D are drawings showing steps of a method for manufacturing the micro rocking device shown in FIG. 10;

FIGS. 14A to 14D are drawings showing steps subsequent to the steps shown in FIG. 13A to 13D;

FIG. 15 is a plan view of a micro rocking device for comparison;

FIG. 16 is a partially omitted plan view of the micro rocking device shown in FIG. 15;

FIG. 17 is a sectional view taken along line XVI-XVII of FIG. 15;

FIG. 18 is a sectional view taken along line XVIII-XVIII of FIG. 15;

FIG. 19 is a sectional view of the micro rocking device during driving, taken along line XVII-XVII of FIG. 15; and

FIG. 20 is a drawing showing the occurrence of sticking between a pair of comb-like electrodes during driving.

### DESCRIPTION OF THE PREFERRED EMBODIMENTS

According to a first embodiment, a micro rocking device includes a frame, a rocking portion, a torsion connecting portion, and a second comb-like electrode, the rocking portion including a first comb-like electrode. The torsion connecting portion connects the frame and the rocking portion. The torsion connecting portion defines the axis of rotational displacement of the rocking portion. The second comb-like electrode attracts the first comb-like electrode to rotationally displace the rocking portion. The first comb-like electrode has a plurality of first parallel electrode teeth which extend in the direction of the axis and which are spaced from each other in a direction crossing the extension direction. The second comb-like electrode has a plurality of second parallel electrode teeth which extend in the direction of the axis and which are spaced from each other in a direction crossing the extension direction. Each of the second electrode teeth has a first side surface on the axis side and a second side surface opposite to the first side surface. The second side surface has a taper region on the side opposite to the first electrode teeth, the region being inclined closer to the axis in a direction away from the first electrode teeth. In the device, the first and second comb-like electrodes function as a driving mechanism for rocking the rocking portion. The device serves as a comb-like electrode-type actuator (a driving force for rotational displacement of the rocking portion may occur between the first and second comb-like electrodes). The device can be applied to, for example, a micro mirror device, an acceleration sensor, an angular velocity sensor, and an oscillating device.

When the rocking portion of the device is rotationally displaced, the larger the distance from the axis of the rocking portion is, the more deeply the first electrode teeth enter between the second electrode teeth of the second comb-like electrode. The distance between the adjacent first and second electrode teeth becomes smaller on the axis side. In the device, the distance between the adjacent first and second electrode teeth is relatively large. Namely, when the rocking portion is rotationally displaced, a sufficient large distance is easily secured between the adjacent first and second electrode teeth as compared with the distance between, for example, adjacent electrode teeth 33a and 43a in a micro rocking device X3 for comparison, which will be described below, when a rocking portion 30 is rotationally displaced. This is because the second side surface of each of the second electrode teeth has a region on the side opposite to the first electrode teeth, the region being inclined closer to the axis in a direction away from the first electrode teeth. When the rocking portion is rotationally displaced, the larger the distance from the axis of the rocking portion is, the more deeply the first electrode teeth enter between the second electrode teeth of the second comb-like electrode. The distance between the adjacent first and second electrode teeth becomes smaller on the axis side. In this embodiment, the second side surface of each of the second electrode teeth of the second comb-like electrode has the above-described taper region, and thus when the rocking portion is rotationally displaced, each of the first electrode teeth of the first comb-like electrode which is attracted to the second comb-like electrode little contacts the adjacent second electrode tooth on the axis side. In addition, a so-called pull-in phenomenon occurs between the first and second electrode teeth. Therefore, minimal sticking occurs between the first and second comb-like electrodes or between the first and second electrode teeth. Thus, the device is suitable for avoiding sticking between a pair of the comb-like electrodes for driving.

In the device, each of the second electrode teeth may have a region on the side opposite to the first electrode teeth, the region being inclined away from the axis in a direction away from the first electrode teeth.

The plurality of first electrode teeth preferably extend in a direction parallel to the axis. In this case, the plurality of second electrode teeth preferably extend in a direction parallel to the extension direction of the first electrode teeth. In order to efficiently produce a driving force for rotational displacement around the axis, between the first and second comb-like electrodes, it is preferred that the extension directions of the first and second electrode teeth are parallel to the axis.

Each of the first and/or second electrode teeth preferably have a region coated with a dielectric thin film. The coating with the dielectric thin film is used for avoiding sticking between a pair of the comb-like electrodes for driving. As the dielectric thin film, a parylene film or a self-organizing monomolecular film of hydrophobic organic molecules such as hexamethyldisilazane (HMDS) is preferably used.

According to a second embodiment, there is provided a method for manufacturing the micro rocking device according to the first embodiment by processing a material substrate having a laminated structure including a first layer, a second layer, and an intermediate layer between the first and second layers. The method includes a step of forming on the second layer a mask pattern including a second electrode teeth mask region which has a pattern shape corresponding to the second electrode teeth of the second comb-like electrode, and a step of anisotropically dry-etching the second layer using the mask pattern. In this method, the second electrode teeth mask region has a taper surface for forming the second side surface of each of the second electrode teeth. The method is capable of appropriately manufacturing the micro rocking device according to the first embodiment.

According to a third embodiment, there is provided another method for manufacturing the micro rocking device according to the first embodiment by processing a material substrate having a laminated structure including a first layer, a second layer, and an intermediate layer between the first and second layers. The method includes a step of forming on the second layer a mask pattern including a second electrode teeth mask region which has a pattern shape corresponding to the second electrode teeth of the second comb-like electrode, and a step of anisotropically dry-etching the second layer using the mask pattern. In this method, in the etching step, a cycle etching process is executed by alternately repeating etching with an etching gas and side wall protection with a protective gas, where the time of etching with the etching gas is increased during the cycle etching process (i.e., in the cycle etching process, the etching time is changed to a longer time only once or the etching time is changed several times to be gradually increased). The method is capable of appropriately manufacturing the micro rocking device according to the first embodiment.

According to a fourth embodiment, there is provided a further method for manufacturing the micro rocking device according to the first embodiment by processing a material substrate having a laminated structure including a first layer, a second layer, and an intermediate layer between the first and second layers. The method includes a step of forming on the second layer a mask pattern including a second electrode teeth mask region which has a pattern shape corresponding to the second electrode teeth of the second comb-like electrode, and a step of anisotropically dry-etching the second layer using the mask pattern. In this method, during the etching step, the etching pressure is reduced in the course of the etching step (i.e., in the etching step, the etching pressure is changed to a predetermined pressure only once or the etching pressure is changed several times to be gradually reduced). The method is capable of appropriately manufacturing the micro rocking device according to the first embodiment.

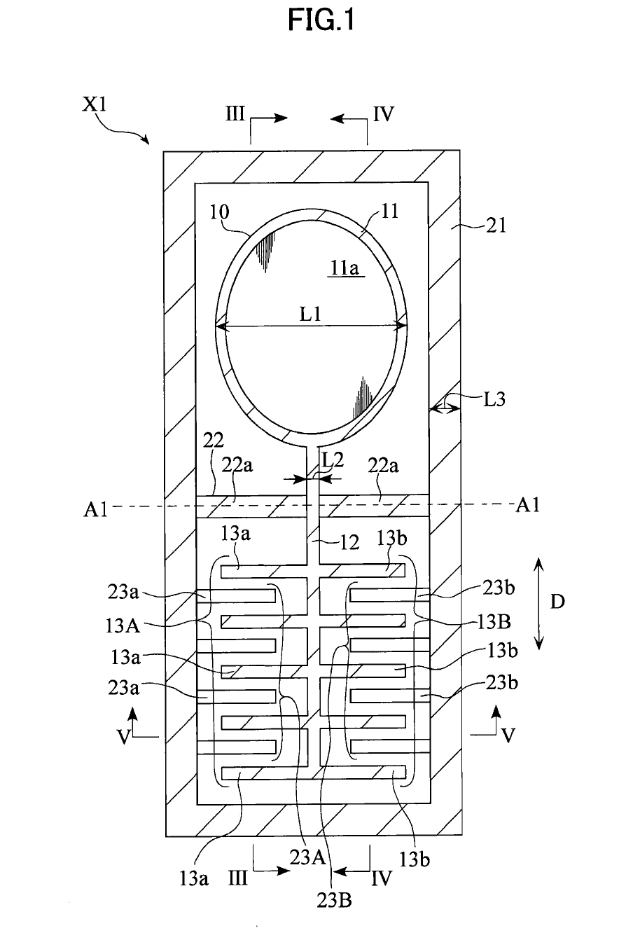

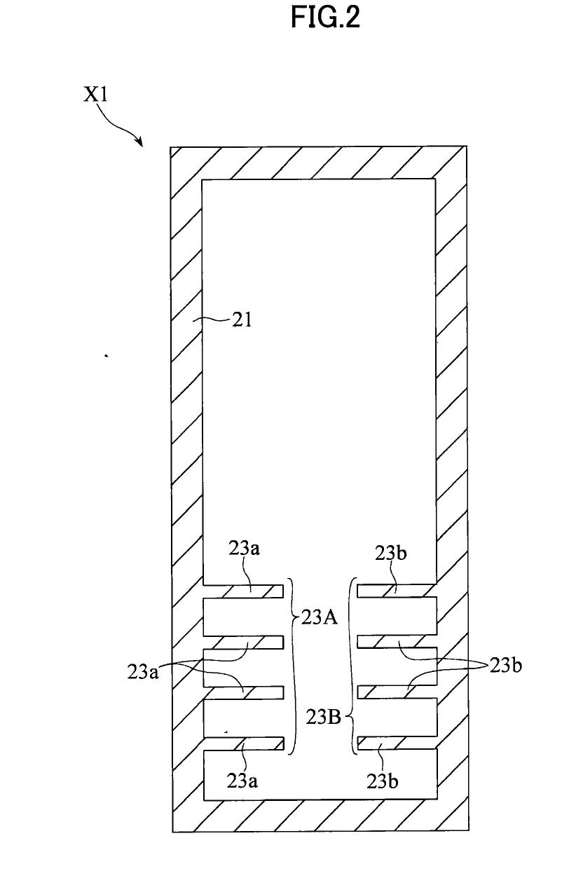

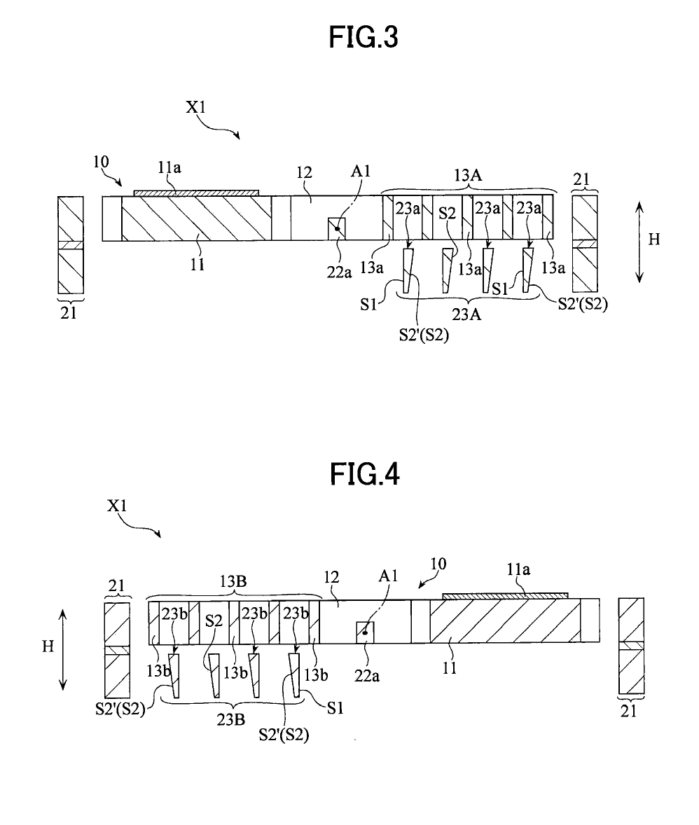

FIGS. 1 to 5 show a micro rocking device X1 according to a first embodiment. FIG. 1 is a plan view of the micro rocking device X1, FIG. 2 is a partially omitted plan view of the micro rocking device X1, and FIGS. 3, 4, and 5 are sectional views taken along lines III-III, IV-IV, and V-V, respectively, of FIG. 1.

The micro rocking device X1 is provided with a rocking portion 10, a frame 21, a torsion connecting portion 22, and comb-like electrodes 23A and 23B. The micro rocking device X1 functions as a micro mirror device. The micro rocking device X1 is manufactured by bulk micro machining technique such as a MEMS (micro-electro-mechanical system) technique. That is, the micro rocking device X1 is manufactured by processing a SOI (silicon on insulator) material substrate. The material substrate has a laminated structure including first and second silicon layers and an insulating layer provided between the silicon layers, and each of the silicon layers is imparted with predetermined conductivity by doping with impurities. Each of the portions on the micro rocking device X1 is mainly derived from the first silicon layer and/or the second silicon layer. From the viewpoint of clarifying the drawings, in FIG. 1, a portion derived from the first silicon layer and projecting from the insulating layer forward in a direction perpendicular to the drawing plane is hatched by oblique lines. FIG. 2 shows a structure derived from the second silicon layer in the micro rocking device X1.

The rocking portion 10 has a mirror support portion 11, an arm portion 12, and comb-like electrodes 13A and 13B.

The mirror support portion 11 is derived from the first silicon layer and has a mirror surface 11a provided on the surface thereof and having a light reflecting function. The mirror surface 11a has a laminated structure including a Cr layer deposited on the first silicon layer and a Au layer deposited on the Cr layer. The length L1 of the mirror support portion 11 shown in FIG. 1 is, for example, 20 to 300 μm.

The arm portion 12 is mainly derived from the first silicon layer and extends from the mirror support portion 11. The length L2 of the arm portion 12 shown in FIG. 1 is, for example, 10 to 100 μm.

The comb-like electrode 13A includes a plurality of electrode teeth 13a. The plurality of electrode teeth 13a extend from the arm portion 12 and are spaced parallel with each other in the extension direction of the arm portion 12. The comb-like electrode 13B includes a plurality of electrode teeth 13b. The plurality of electrode teeth 13b extend from the arm portion 12 in the direction opposite to the electrode teeth 13a and are spaced parallel with each other in the extension direction of the arm portion 12. The electrode teeth 13a and 13b are mainly derived from the first silicon layer. In this embodiment, as shown in FIG. 1, the extension direction of the electrode teeth 13a and 13b is perpendicular to the extension direction of the arm portion 12. The comb-like electrode 13A (i.e., the electrode teeth 13a) is electrically connected to the comb-like electrode 13B (i.e., the electrode teeth 13b) through the arm portion 12.

The frame 21 is mainly derived from the first and second silicon layers and has a shape which surrounds the rocking portion 10. FIG. 2 shows a portion of the frame 21, which is derived from the second silicon layer. In addition, the frame 21 has predetermined mechanical strength for supporting a structure inside the frame 21. The length L3 of the frame 21 shown in FIG. 1 is, for example, 5 to 50 μm.

The torsion connecting portion 22 includes a pair of torsion bars 22a each of which are mainly derived from the first silicon layer. Each of the torsion bars 22a is connected to the arm portion 12 of the rocking portion 10 and to a portion of the frame 21, which is derived from the first silicon layer, to connect the arm portion 12 and the frame 21. The portion of the frame 21, which is derived from the first layer, is electrically connected to the arm portion 12 through the torsion bars 22a. As shown in FIG. 3, the torsion bars 22a are thinner than the arm portion 12 and thinner than the portion of the frame 21, which is derived from the first layer, in the thickness direction H of the device. The torsion connecting portion 22, i.e., the pair of torsion bars 22a, defines the axis A1 of rotational displacement of the rocking portion 10 or the mirror support portion 11. The axis A1 is perpendicular to the arrow direction D, as shown in FIG. 1, (i.e., the extension direction of the arm portion 12). Therefore, the extension direction of the electrode teeth 13a and 13b which extend from the arm portion 12 in the direction perpendicular to the extension direction of the arm portion 12 are parallel to the axis A1. The axis A1 preferably passes through the center of gravity of the rocking portion 10 or a vicinity thereof.

In this embodiment, a pair of parallel torsion bars which are formed by the first silicon layer may be provided instead of each of the torsion bars 22a. In this case, the distance between the torsion bars preferably gradually increases in the direction from the frame 21 to the arm portion 12. In the micro rocking device X1, the axis A1 may be defined by providing two pairs of parallel torsion bars instead of the pair of torsion bars 22a. This applies to micro rocking devices which will be described below.

The comb-like electrode 23A generates electrostatic attraction by cooperation with the comb-like electrode 13A. The comb-like electrode 23A includes a plurality of electrode teeth 23a derived from the second silicon layer. The plurality of electrode teeth 23a extend from the frame 21 and are spaced parallel with each other in the extension direction of the arm portion 12. In this embodiment, as shown in FIG. 1, the extension direction of the electrode teeth 23a is perpendicular to the extension direction of the arm portion 12 and is parallel to the axis A1. In addition, each of the electrode teeth 23a has a side surface S1 on the axis A1 side and a side surface S2 on the side opposite to the side surface S1. As shown in FIG. 3, the side surface S2 has a taper region S2, which is inclined closer to the axis A1 in a direction away from the electrode teeth 13a. The taper region S2′ is provided at least on the side of each of the electrode teeth 23a opposite to the electrode teeth 13a. FIG. 3 shows a case in which the taper region S2′ is provided over the whole of the side surface S2.

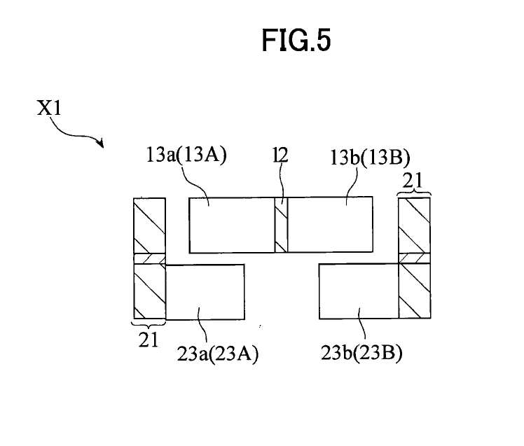

The comb-like electrode 23A functions as a driving mechanism in cooperation with the comb-like electrode 13A. For example, when the rocking portion 10 is not operated, as shown in FIGS. 3 and 5, the comb-like electrodes 13A and 23A are positioned at different heights. Therefore, the electrode teeth 13a and 23a of the comb-like electrodes 13A and 23A are arranged in a staggered form so that the comb-like electrodes 13A and 23A do not contact each other when the rocking portion 10 is operated. In addition, the distance between the adjacent two electrode teeth 13a is constant, and the distance between the adjacent two electrode teeth 23a is constant. Further, each of the electrode teeth 13a positioned between the adjacent two electrode teeth 23a is at the center between the adjacent two electrode teeth 23a in the extension direction of the arm portion 12.

The comb-like electrode 23B generates electrostatic attraction by cooperation with the comb-like electrode 13B. The comb-like electrode 23B includes a plurality of electrode teeth 23b derived from the second silicon layer. The plurality of electrode teeth 23b extend from the frame and are spaced parallel with each other in the extension direction of the arm portion 12. The comb-like electrode 23B, i.e., the electrode teeth 23b, is electrically connected to the comb-like electrode 23A, i.e., the electrode teeth 23a, through the portion of the arm portion which is derived from the second silicon layer. In this embodiment, as shown in FIG. 1, the extension direction of the electrode teeth 23b is perpendicular to the extension direction of the arm portion 12 and is parallel to the axis A1. In addition, each of the electrode teeth 23b has a side surface S1 on the axis A1 side and a side surface S2 on the side opposite to the side surface S1. As shown in FIG. 4, the side surface S2 has a taper region S2 which is inclined closer to the axis A1 in a direction away from the electrode teeth 13b. The taper region S2′ is provided at least on the side of each of the electrode teeth 23b opposite to the electrode teeth 13b. FIG. 4 shows a case in which the taper region S2′ is provided over the whole of the side surface S2.

The comb-like electrode 23B functions as a driving mechanism in cooperation with the comb-like electrode 13B. For example, when the rocking portion 10 is not operated, as shown in FIGS. 4 and 5, the comb-like electrodes 13B and 23B are positioned at different heights. Therefore, the electrode teeth 13b and 23b of the comb-like electrodes 13B and 23B are arranged in a staggered form so that the comb-like electrodes 13B and 23B do not contact each other when the rocking portion 10 is operated. In addition, the distance between the adjacent two electrode teeth 13b is constant, and the distance between the adjacent two electrode teeth 23b is constant. Further, each of the electrode teeth 13b positioned between the adjacent two electrode teeth 23b is at the center between the adjacent two electrode teeth 23a in the extension direction of the arm portion 12.

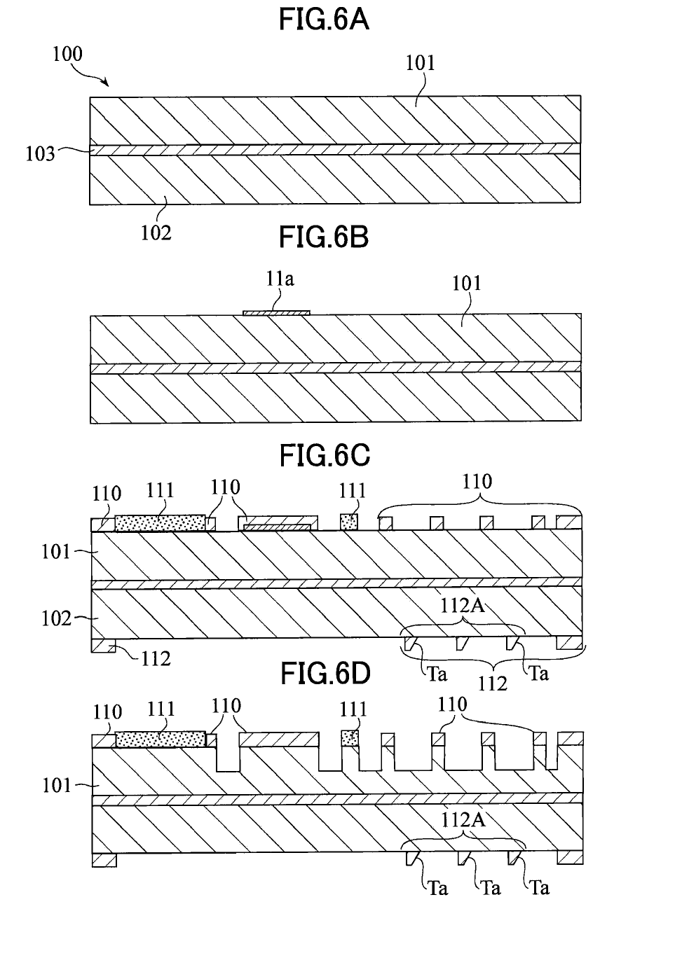

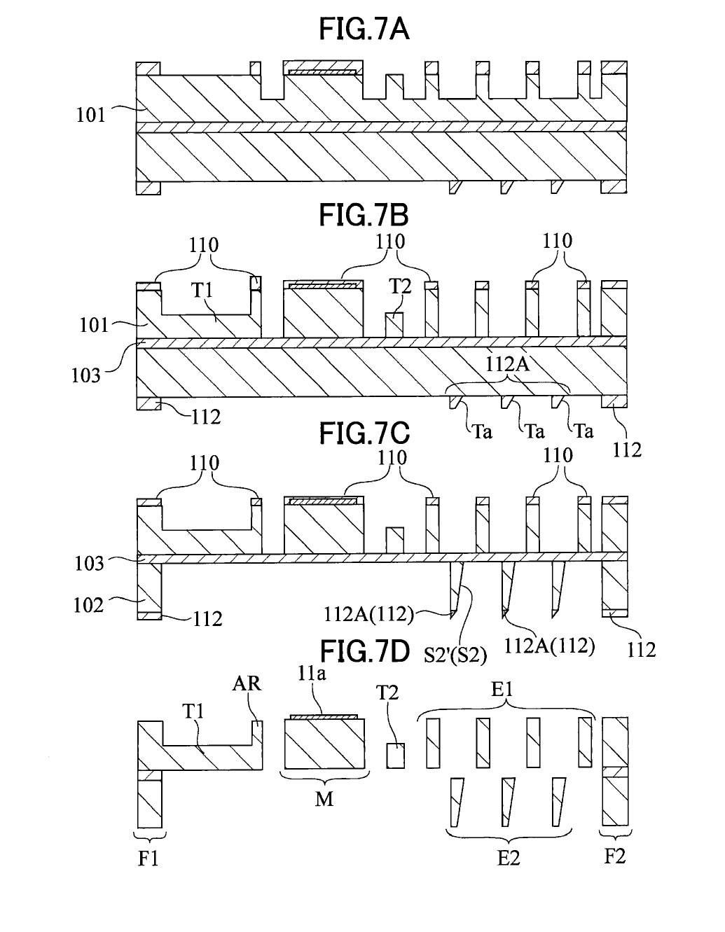

FIGS. 6A to 6D and 7A to 7D show an example of a method for manufacturing the micro rocking device X1. This method is a method for manufacturing the micro rocking device X1 by a bulk micromachining technique. In FIGS. 6A to 6D and 7A to 7D, the process for forming a mirror support portion M, an arm portion AR, frames F1 and F2, torsion bars T1 and T2, and a pair of comb-like electrodes E1 and E2, as shown in FIG. 7D, is shown by changes in a section. The section is shown as a continuous section formed for modeling sections at a plurality of positions included in a region where a single micro rocking device is formed in a material substrate (wafer having a multilayer structure) to be processed. The mirror support portion M corresponds to a portion of the mirror support portion 11, and the arm portion AR corresponds to the arm portion 12 and represents a cross-section of the arm portion 12. The frames F1 and F2 each correspond to the frame 21 and represent a cross section of the frame 21. The torsion bar T1 corresponds to the torsion bar 22a and represents a section of the torsion bar 22a in the extension direction thereof. The torsion bar T2 corresponds to the torsion bar 22a and represents a cross section of the torsion bar 22a. The comb-like electrode E1 corresponds to a portion of the comb-like electrodes 13A and 13B and represents cross sections of the electrode teeth 13a and 13b. The comb-like electrode E2 corresponds to a portion of the comb-like electrodes 23A and 23B and represents cross sections of the electrode teeth 23a and 23b.

The process for manufacturing the micro rocking device X1 is described. A material substrate 100 as shown in FIG. 6A is prepared. The material substrate 100 is a SOI substrate having a laminated structure including silicon layers 101 and 102 and an insulating layer 103 provided between the silicon layers 101 and 102. The silicon layers 101 and 102 are composed of a silicon material imparted with conductivity by doping with impurities. As the impurities, p-type impurities such as B or n-type impurities such as P or Sb can be used. The insulating layer 103 is composed of, for example, silicon oxide. The thickness of the silicon layer 101 is, for example, 10 to 100 μm, the thickness of the silicon layer 102 is, for example, 50 to 500 μm, and the thickness of the insulating layer 103 is, for example, 0.3 to 3 μm.

Next, as shown in FIG. 6B, the mirror surface 11a is formed on the silicon layer 101. In order to form the mirror surface 11a, first, for example, Cr (50 nm) is deposited on the silicon layer 101 and then Au (200 μm) is deposited on Cr by sputtering. Then, these metal films are etched in order through a predetermined mask to pattern the mirror surface 11a. As an etchant for Au, for example, an aqueous potassium iodide-iodine solution can be used. As an etchant for Cr, for example, a mixed solution of an aqueous ammonium cerium(IV) nitrate solution and perchloric acid can be used.

Next, as shown in FIG. 6C, an oxide film pattern 110 and a resist pattern 111 are formed on the silicon layer 101, and a resist pattern 112 is formed on the silicon layer 102. The oxide film pattern 110 has a pattern form corresponding to the rocking portion 10 (the mirror support portion M, the arm portion AR, and the comb-like electrode E1) and the frame 21 (the frames F1 and F2). The oxide film pattern 110 is formed by, for example, a CVD process. The resist pattern 111 has a pattern form corresponding to both torsion bars 22a (the torsion bars T1 and T2). The resist pattern 111 can be formed by depositing a photoresist on the silicon layer 101 by spin coating, exposing the photoresist to light using a predetermined mask, and developing the photoresist using a predetermined developer (other resist patterns described below can also be formed by such spin coating, exposure, and development).

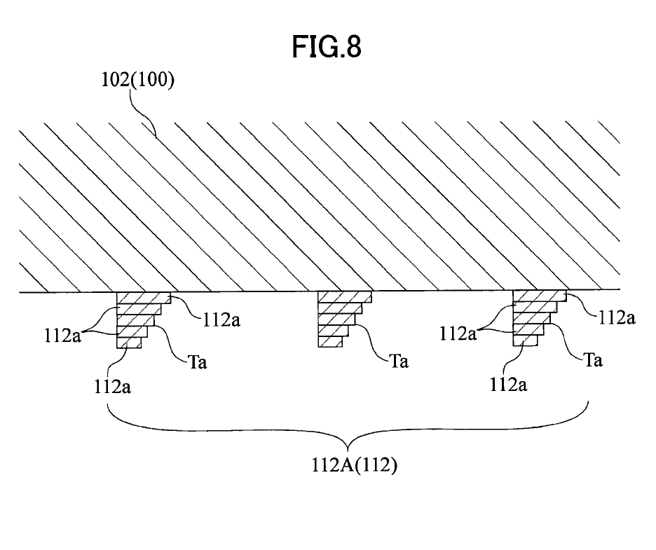

The resist pattern 112 has a pattern form corresponding to the frame 21 (the frames F1 and F2) and includes an electrode teeth mask region 112A having a pattern form corresponding to the comb-like electrodes 23A and 23B (the comb-like electrode E2). The mask region 112A has taper surfaces Ta for forming the side surfaces S2 of the electrode teeth 23a and 23b of the comb-like electrodes 23A and 23B. The mask region 112A can be formed, for example, using a so-called gray mask as a photomask in the exposure step for forming the resist pattern 112. The gray mask is a photomask capable of providing a quantity distribution of transmitted light in a predetermined pattern. When such a gray mask is used as a photomask in the exposure step for forming the resist pattern 112, an exposure gradation can be partially provided in a predetermined portion of the photoresist so that the taper surfaces Ta can be formed in the mask region 112A of the resist pattern 112 by development of portions provided with the exposure gradation (a portion with a smaller exposure in the photoresist becomes a relatively thick portion after the development step). Alternatively, as shown in FIG. 8, the mask region 112A may be formed by laminating a plurality of thin resist patterns 112a to form the taper surfaces Ta.

Next, as shown in FIG. 6D, the silicon layer 101 is etched to a predetermined depth by DRIE (deep reactive ion etching). The etching is performed using the oxide film pattern 110 and the resist pattern 111 as a mask. The predetermined depth corresponds to the thickness of the torsion bars T1 and T2 and is, for example, 5 μm. In the DRIE, etching with SF₆ gas and side wall protection with C₄F₈ gas are alternately repeated. This process is referred to as “Bosch process” which is capable of satisfactory anisotropic etching. DRIE which will be described below can also be performed by the Bosch process. Deterioration in the oxide film pattern 110 and the resist pattern 111 due to the etching is not shown in the drawings from the viewpoint of simplification of the drawings.

Next, as shown in FIG. 7A, the resist pattern 111 is removed by the action of a remover. As the remover, for example, AZ remover 700 (manufactured by AZ Electronic Materials) can be used.

Next, as shown in FIG. 7B, etching is performed by DRIE using the oxide film pattern 110 as a mask. The etching is performed for the silicon layer 101 until the insulating layer 103 appears while leaving the torsion bars T1 and T2. By the etching, the rocking portion 10 (the mirror support portion M, the arm portion AR, and the comb-like electrode E1), both torsion bars 22a (the torsion bars T1 and T2), and a portion of the frame 21 (the frames F1 and F2) are formed.

Next, as shown in FIG. 7C, etching is performed by DRIE using the resist pattern 112 including the mask region 112A as a mask. The etching is performed for the silicon layer 102 until the insulating layer 103 appears. During the etching, a portion of the frame 21 (the frames F1 and F2) and the comb-like electrodes 23A and 23B (the comb-like electrode E2) including the electrode teeth 23a and 23b are formed. In the etching step, the resist pattern 112 is gradually degraded, and the mask region 112A having the taper surfaces Ta is gradually thinned. Namely, the mask region 112A is gradually corroded from relatively thin portions to gradually decrease the masking area of the mask region 112a. Therefore, as shown in FIG. 7C, the taper regions S2′ are formed on the side surfaces S2 of the electrode teeth 23a and 23b in response to gradual decreases in the masking area of the mask region 112A.

Next, as shown in FIG. 7D, the exposed portions of the insulating film 103 and the oxide film pattern 110 are removed, and the resist pattern 112 is removed. The exposed portions of the insulating film 103 and the oxide film pattern 110 can be removed by dry etching or wet etching. In the dry etching, for example, CF₄ or CHF₃ can be used as an etching gas, while in the wet etching, for example, buffered hydrofluoric acid (BHF) containing hydrofluoric acid and ammonium fluoride can be used as an etching solution. On the other hand, the resist pattern 112 is removed by the action of a predetermined remover.

As a result, the mirror support portion M, the arm portion AR, the frames F1 and F2, the torsion bars T1 and T2, and a pair of the comb-like electrodes E1 and E2 can be formed through a series of the above-described steps to form the micro rocking device X1.

In the micro rocking device X1, when a predetermined potential is applied to each of the comb-like electrodes 13A, 13B, 23A, and 23B according to demand, the rocking portion 10 or the mirror support portion 11 can be rotationally displaced around the axis A1. The application of the predetermined potential to the comb-like electrodes 13A and 13B can be realized through the portion of the frame 21 which is derived from the first silicon layer, the torsion bars 22a, and the arm portion 12. The comb-like electrodes 13A and 13B are, for example, grounded. The application of the predetermined potential to the comb-like electrodes 23A and 23B can be realized through the portion of the frame 21 which is derived from the second silicon layer. The insulating layer is interposed between the portion derived from the first silicon layer and the portion derived from the second silicon layer in the frame 21, and thus the portions derived from the first silicon layer and the second silicon layer are electrically separated.

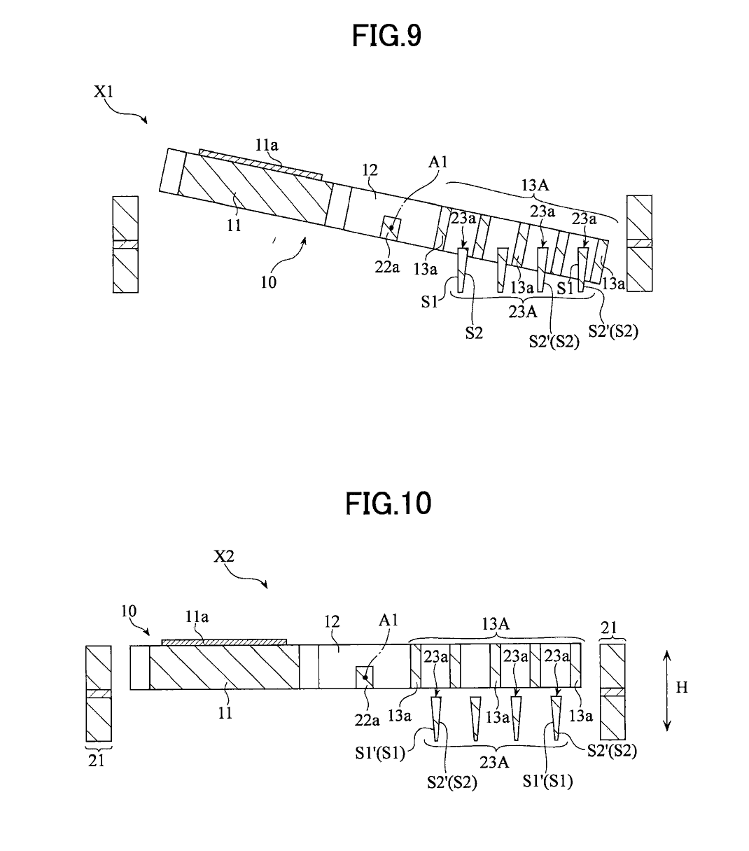

When the predetermined potential is applied to each of the comb-like electrodes 13A, 13B, 23A, and 23B to produce the desired electrostatic attraction between the comb-like electrodes 13A and 23A and between the comb-like electrodes 13B and 23B, the comb-like electrode 13A is attracted to the comb-like electrode 23A, and the comb-like electrode 13B is pulled into the comb-like electrode 23B. Therefore, the rocking portion 10 or the mirror support portion 11 makes a rocking motion around the axis A1 and is rotationally displaced to an angle at which the electrostatic attraction is balanced with the total torsion resistance of the torsion bars 22a. In the balanced state, the comb-like electrode 13A and the comb-like electrode 23A are oriented as shown in FIG. 9, and the comb-like electrode 13B and the comb-like electrode 23B are also oriented as shown in FIG. 9. The rotational displacement in the rocking motion can be adjusted by controlling the potential applied to the comb-like electrodes 13A, 23A, 13B, and 23B. In addition, when the electrostatic attraction between the comb-like electrodes 13A and 23A and the electrostatic attraction between the comb-like electrodes 13B and 23B are disappeared, each of the torsion bars 22a returns to its natural state, and the rocking portion 10 or the mirror support portion 11 is oriented as shown in FIGS. 3 to 5. Therefore, the reflection direction of light reflected by the mirror surface 11a provided on the mirror support portion 11 can be appropriately changed by the rocking drive of the rocking portion 10 or the mirror support portion 11.

When the rocking portion 10 of the micro rocking device X1 is rotationally displaced, the larger the distance from the axis X1 is, the more deeply the electrode teeth 13a enter between the electrode teeth 23a of the comb-like electrode 23A. The distance between the adjacent electrode teeth 13a and 23a becomes smaller on the center side. Similarly, the larger the distance from is, the more deeply the axis X1 the electrode teeth 13b enter between the electrode teeth 23b of the comb-like electrode 23B. The distance between the adjacent electrode teeth 13b and 23b is smaller on the center side. In the rocking device X1, however, the distance between the adjacent electrode teeth 13a and 23a and the distance between the adjacent electrode teeth 13b and 23b are relatively large. Namely, when the rocking portion 10 is rotationally displaced, a sufficiently large distance is easily secured between the adjacent electrode teeth 13a and 23a and between the adjacent electrode teeth 13b and 23b as compared with the distance between, for example, adjacent electrode teeth 33a and 43a in a micro rocking device X3 for comparison, which will be described below, when a rocking portion 30 is rotationally displaced. This is because the side surface S2 of each of the electrode teeth 23a has a taper region S2′ inclined closer to the axis A1 in a direction away from the electrode teeth 13a. In addition, the side surface S2 of each of the electrode teeth 23b has a taper region S2′ inclined closer to the axis A1 in a direction away from the electrode teeth 13b. Therefore, minimal sticking occurs between the comb-like electrodes 13A and 23A (between the electrode teeth 13a and 23a) and between the comb-like electrodes 13B and 23B (between the electrode teeth 13b and 23b).

The structure of the micro rocking device X1 is described as follows. The plurality of electrode teeth 13a of the comb-like electrode 13A are spaced from each other in the extension direction of the arm portion 12 extending from the mirror support portion 11 and are supported by the arm portion 12. The plurality of electrode teeth 23a of the comb-like electrode 23A are spaced from each other in the extension direction of the arm portion 12 and are supported by the arm portion 12. On the other hand, the plurality of electrode teeth 13b of the comb-like electrode 13B are spaced from each other in the extension direction of the arm portion 12 extending from the mirror support portion 11 and are supported by the arm portion 12. The plurality of electrode teeth 23b of the comb-like electrode 23B are spaced from each other in the extension direction of the arm portion 12 and are supported by the arm portion 12. The electrode teeth 13a, 13b, 23a, and 23b are not directly supported by the mirror support portion 11. Therefore, the size of a pair of the comb-like electrodes 13A and 23A are not restricted by the length of the mirror support portion 11 in the extension direction of the axis A1 perpendicular to the extension direction of the arm portion 12. Namely, the numbers of the electrode teeth 13a and 23a are not restricted by the length of the mirror support portion 11 in the extension direction of the axis A1 perpendicular to the extension direction of the arm portion 12. In addition, the size of a pair of the comb-like electrodes 13B and 23B are not restricted by the length of the mirror support portion 11 in the extension direction of the axis A1 perpendicular to the extension direction of the arm portion 12. Namely, the numbers of the electrode teeth 13b and 23b are not restricted by the length of the mirror support portion 11 in the extension direction of the axis A1 perpendicular to the extension direction of the arm portion 12. Therefore, in the micro rocking device X1, the desired numbers of the electrode teeth 13a, 13b, 23a, and 23b can be provided regardless of the design dimension of the mirror support portion 11 in the axis A1 direction so that a necessary opposable area can be secured between the electrode teeth 13a and 23a and between 13b and 23b. Therefore, since the desired numbers of the electrode teeth 13a, 13b, 23a, and 23b can be provided regardless of the design dimension of the mirror support portion 11 in the axis A1 direction, the micro rocking device X1 is suitable for reducing the size by setting a short design dimension of the mirror support portion (i.e., the whole device) in the axis A1 direction while securing driving force for a rocking motion of the rocking portion 10.

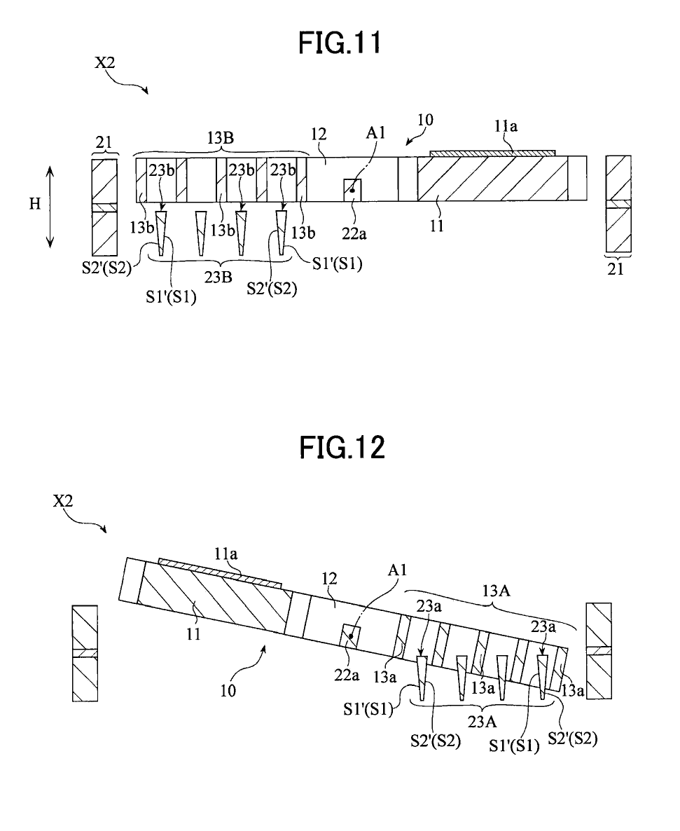

FIGS. 10 and 11 are sectional views each showing a micro rocking device X2 according to a second embodiment. The micro rocking device X2 is provided with a rocking portion 10, a frame 21, a torsion connecting portion 22, and comb-like electrodes 23A and 23B. The micro rocking device X2 functions as a micro mirror device. The micro rocking device X2 is different from the above-described micro rocking device X1 in that the side surface S1 of each of the electrode teeth 23a and 23b of the comb-like electrodes 23A and 23B has a taper region S1′.

Each of the electrode teeth 23a of the comb-like electrode 23A has the side surface S1 on the axis A1 side and the side surface S2 on the side opposite to the side surface S1. As shown in FIG. 10, the side surface S1 has the taper region S1′ which is inclined away from the axis A1 in a direction away from the electrode teeth 13a. The taper region S1′ is provided at least on the side of each of the electrode teeth 23a opposite to the electrode teeth 13a. FIG. 10 shows a case in which the taper region S1′ is provided over the whole of the side surface S1. On the other hand, each of the electrode teeth 23b of the comb-like electrode 23B has the side surface S1 on the axis A1 side and the side surface S2 on the side opposite to the side surface S1. As shown in FIG. 11, the side surface S1 has the taper region S1′ which is inclined away from the axis A1 in a direction away from the electrode teeth 13b. The taper region S1′ is provided at least on the side of each of the electrode teeth 23b opposite to the electrode teeth 13b. FIG. 11 shows a case in which the taper region S1′ is provided over the whole of the side surface S1.

The micro rocking device X2 having the above-described structure produces rotational displacement in the same manner as the micro rocking device X1. In the micro rocking device X2, when a predetermined potential is applied to the comb-like electrodes 13A, 13B, 23A, and 23B according to demand, rotational displacement takes place. In the micro rocking device X2, for example, as shown in FIG. 12, the rocking portion 10 or the mirror support portion 11 can be rotationally displaced around the axis A1. In the rotational displacement, for the same reasons as described above with respect to the micro rocking device X1, minimal sticking occurs between the comb-like electrodes 13A and 23A (between the electrode teeth 13a and 23a) and between the comb-like electrodes 13B and 23B (between the electrode teeth 13b and 23b). In addition, like the micro rocking device X1, the micro rocking device X2 is suitable for reducing the size. Further, in the micro rocking device X2, desired numbers of the electrode teeth 13a, 13b, 23a, and 23b can be provided regardless of the design dimension of the mirror support portion 11 in the axis A1 direction. Therefore, in the micro rocking device X2, a driving force for a rocking motion of the rocking portion 10 can be secured. Further, in the micro rocking device X2, the design dimension of the mirror support portion 11 in the axis A1 direction can be set to be short. Therefore, the micro rocking device X2 is suitable for reducing the design dimensions of the whole device.

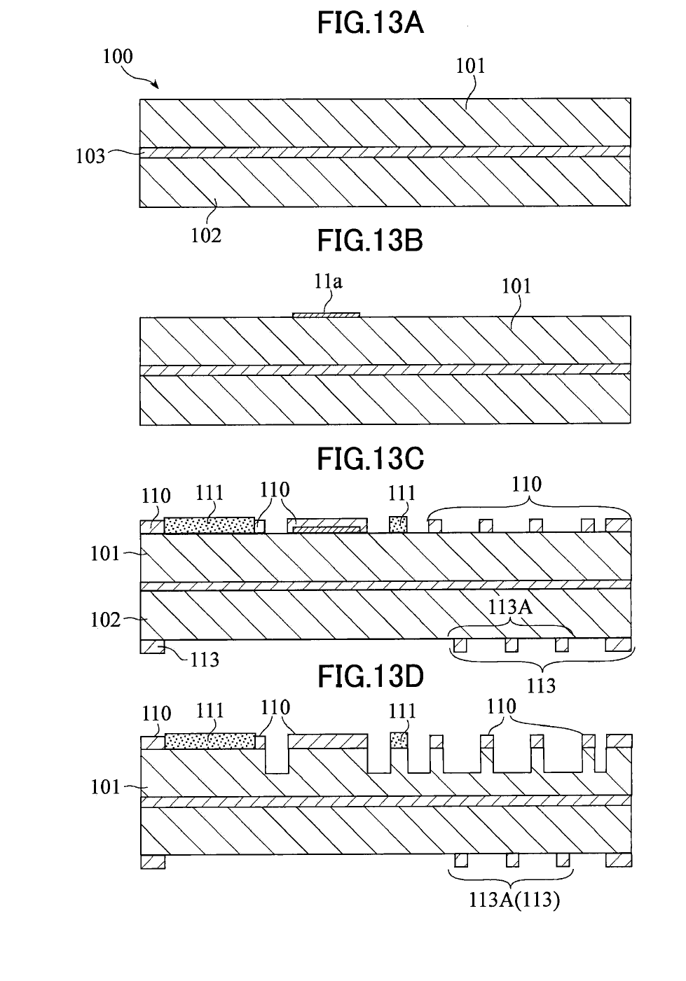

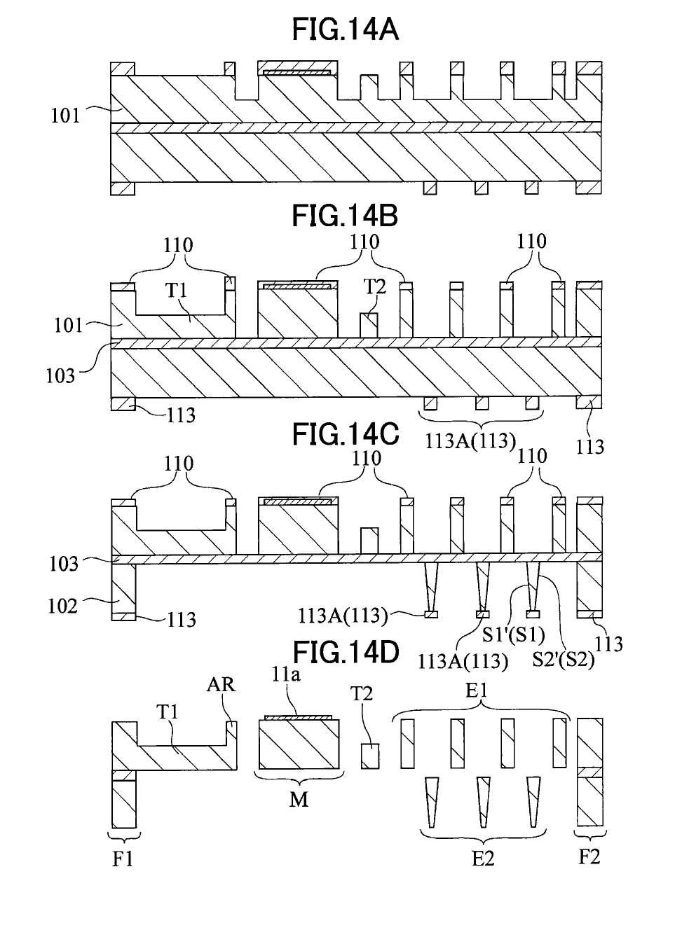

FIGS. 13A to 13D and 14A to 14D show an example of a method for manufacturing the micro rocking device X2. This method is a method for manufacturing the micro rocking device X2 by a bulk micromachining technique. In FIGS. 13A to 13D and 14A to 14D, the process for forming a mirror support portion M, an arm portion AR, frames F1 and F2, torsion bars T1 and T2, and a pair of comb-like electrodes E1 and E2, as shown in FIG. 14D, are shown by changes in a section. The section is shown as a continuous section formed for modeling sections at a plurality of positions included in a region where a single micro rocking device is formed in a material substrate (wafer having a multilayer structure) to be processed. The mirror support portion M corresponds to a portion of the mirror support portion 11, and the arm portion AR corresponds to the arm portion 12 and represents a cross-section of the arm portion 12. The frames F1 and F2 each correspond to the frame 21 and represent a cross section of the frame 21. The torsion bar T1 corresponds to the torsion bar 22a and represents a section of the torsion bar 22a in the extension direction thereof. The torsion bar T2 corresponds to the torsion bar 22a and represents a cross section of the torsion bar 22a. The comb-like electrode E1 corresponds to a portion of the comb-like electrodes 13A and 13B and represents cross sections of the electrode teeth 13a and 13b. The comb-like electrode E2 corresponds to a portion of the comb-like electrodes 23A and 23B and represents cross sections of the electrode teeth 23a and 23b.

The process for manufacturing the micro rocking device X2 is described as follows. A material substrate 100, as shown in FIG. 13A, is prepared. The material substrate 100 is a SOI substrate having a laminated structure including silicon layers 101 and 102 and an insulating layer 103 provided between the silicon layers 101 and 102. The silicon layers 101 and 102 are composed of a silicon material imparted with conductivity by doping with impurities.

Next, as shown in FIG. 13B, the mirror surface 11a is formed on the silicon layer 101. The mirror surface 11a is formed by the same method as described above with reference to FIG. 6B.

Next, as shown in FIG. 13C, an oxide film pattern 110 and a resist pattern 111 are formed on the silicon layer 101, and an oxide film pattern 113 are formed on the silicon layer 102. The oxide film pattern 110 has a pattern form corresponding to the rocking portion 10 (the mirror support portion M, the arm portion AR, and the comb-like electrode E1) and the frame 21 (the frames F1 and F2). The resist pattern 111 has a pattern form corresponding to both torsion bars 22a (the torsion bars T1 and T2). The oxide film pattern 113 has a pattern form corresponding to the frame 21 (the frames F1 and F2) and includes an electrode teeth mask region 113A having a pattern form corresponding to the comb-like electrodes 23A and 23B (the comb-like electrode E2).

Next, as shown in FIG. 13D, the silicon layer 101 is etched to a predetermined depth by DRIE using the oxide film pattern 110 and the resist pattern 111 as a mask. Specifically, the etching is performed by the same method as described above with reference to FIG. 6D.

Next, as shown in FIG. 14A, the resist pattern 111 is removed by the action of a predetermined remover.

Next, as shown in FIG. 14B, etching is performed by DRIE using the oxide film pattern 110 as a mask. The etching is performed for the silicon layer 101 until the insulating layer 103 appears while leaving the torsion bars T1 and T2. During the etching, the rocking portion 10 (the mirror support portion M, the arm portion AR, and the comb-like electrode E1), both torsion bars 22a (the torsion bars T1 and T2), and a portion of the frame 21 (the frames F1 and F2) are formed.

Next, as shown in FIG. 14C, etching is performed by DRIE using the oxide film pattern 113 including the mask region 113A as a mask. The etching is performed for the silicon layer 102 until the insulating layer 103 appears. During the etching, etching with an etching gas (SF₆ gas) and side wall protection with a protective gas (C₄F₈ gas) are alternately repeated. This cycle etching process in which etching and side wall protection are alternately repeated is referred to as “Bosch process”. The etching is performed by the Bosch process. During the etching process, the etching time is increased (i.e., in the cycle etching process, the etching time is changed to a longer time only once or the etching time is changed several times to be gradually increased). Alternatively, in the etching step, the etching pressure is reduced in the course of the etching step (i.e., in the etching step, the etching pressure is changed to a predetermined lower pressure only once or the etching pressure is changed several times to be gradually reduced). When the time of etching with the etching gas is changed as described above or the etching pressure is changed as described above, anisotropy in the etching process is decreased. In the etching process, thereof, the taper regions S1′ and S2′ are formed on the side surfaces S1 and S2, respectively, of each of the electrode teeth 23a and 23b.

Next, as shown in FIG. 14D, the exposed portions of the insulating film 103, the oxide film pattern 110, and the oxide film pattern 113 are removed. The removal method is the same as described above for removal of the oxide film pattern 110 and the like with reference to FIG. 7D.

As a result, the mirror support portion M, the arm portion AR, the frames F1 and F2, the torsion bars T1 and T2, and a pair of the comb-like electrodes E1 and E2 can be formed through a series of the above-described steps to form the micro rocking device X2.

In each of the micro rocking devices X1 and X2, each of the electrode teeth 13a, 13b, 23a, and 23b composed of a conductor material may be partially or entirely coated with a thin film composed of a predetermined dielectric material. As such a thin film, a parylene film or a self-organizing monomolecular film of hydrophobic organic molecules such as hexamethyldisilazane (HMDS) can be used. Partial or entire coating of each of the electrode teeth 13a, 13b, 23a, and 23b with a dielectric thin film contributes to the suppression of sticking between the electrodes.

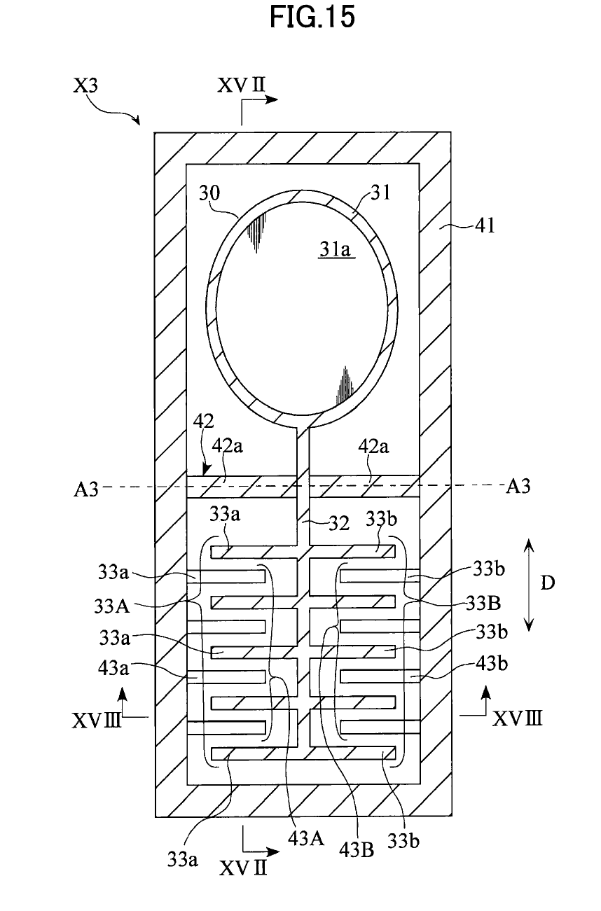

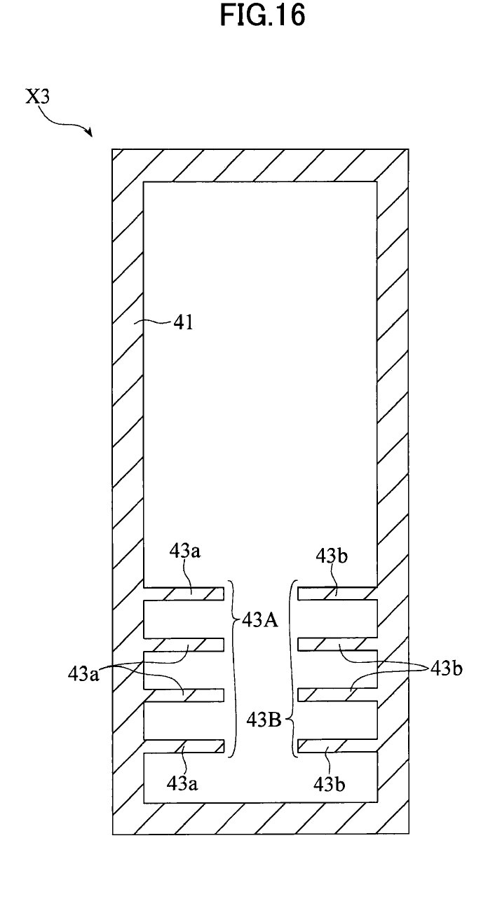

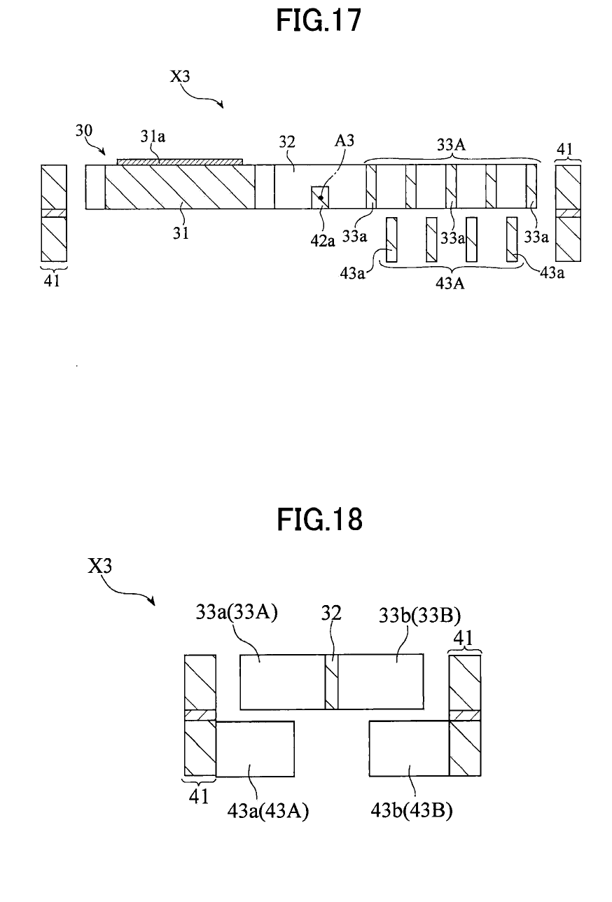

FIGS. 15 to 18 show a micro rocking device X3 for comparison to the embodiments. FIG. 15 is a plan view of the micro rocking device X3, FIG. 16 is a partially omitted plan view of the micro rocking device X3, and FIGS. 17 and 18 are sectional views taken along lines XVII-XvII and XVIII-XVIII, respectively, of FIG. 15.

The micro rocking device X3 is provided with a rocking portion 30, a frame 41, a torsion connecting portion 42, and comb-like electrodes 43A and 43B. The micro rocking device X3 is manufactured by bulk micro machining technique such as a MEMS technique. That is, the micro rocking device X3 is manufactured by processing a SOI (silicon on insulator) substrate used as a material substrate. The material substrate has a laminated structure including first and second silicon layers and an insulating layer provided between the silicon layers, and each of the silicon layers are imparted with predetermined conductivity by doping with impurities. Each of the portions on the micro rocking device X3 are mainly derived from the first silicon layer and/or the second silicon layer. From the viewpoint of clarifying the drawings, in FIG. 15, a portion derived from the first silicon layer and projecting from the insulating layer forward in a direction perpendicular to the drawing plane is hatched with oblique lines. FIG. 16 shows a structure derived from the second silicon layer in the micro rocking device X3.

The rocking portion 30 has a mirror support portion 31, an arm portion 32, and comb-like electrodes 33A and 33B. The mirror support portion 31 is derived from the first silicon layer and has a mirror surface 31a provided on the surface thereof and having a light reflecting function. The arm portion 32 is mainly derived from the first silicon layer and extends from the mirror support portion 31. The comb-like electrode 33A include a plurality of electrode teeth 33a which extend from the arm portion 32 and are spaced from each other in the extension direction of the arm portion 32. The extension direction of the electrode teeth 33a is perpendicular to the extension direction of the arm portion 32. The comb-like electrode 33B includes a plurality of electrode teeth 33b which extend from the arm portion 32 in the direction opposite to the electrode teeth 33a and are spaced from each other in the extension direction of the arm portion 32. The extension direction of the electrode teeth 33b is perpendicular to the extension direction of the arm portion 32. The electrode teeth 33a and 33b are mainly derived from the first silicon layer and electrically connected to each other through the arm portion 32.

The frame 41 is mainly derived from the first and second silicon layers and has a shape which surrounds the rocking portion 30. FIG. 16 shows a portion of the frame 41, which is derived from the second silicon layer.

The torsion connecting portion 42 includes a pair of torsion bars 42a each of which is derived from the first silicon layer. Each of the torsion bars 42a is connected to the arm portion 32 of the rocking portion 30 and to a portion of the frame 41, which is derived from the first silicon layer, to connect the arm portion 32 and the frame 41. The portion of the frame 41, which is derived from the first layer, is electrically connected to the arm portion 32 through the torsion bars 42a. The torsion connecting portion 42, i.e., the pair of torsion bars 42a, defines the axis A3 of rocking motion of the rocking portion 30 or the mirror support portion 31. The axis A3 is perpendicular to the arrow direction D, as shown in FIG. 15, i.e., the extension direction of the arm portion 32. Therefore, the extension direction of the electrode teeth 33a and 33b which extend from the arm portion 32 in the direction perpendicular to the extension direction of the arm portion 32 is parallel to the axis A3.

The comb-like electrode 43A generates electrostatic attraction by cooperation with the comb-like electrode 33A. The comb-like electrode 43A includes a plurality of electrode teeth 43a. The plurality of electrode teeth 43a extend from the frame 41 and are spaced from each other in the extension direction of the arm portion 32.

In addition, the comb-like electrode 43A is mainly derived from the second silicon layer and is fixed to the portion of the frame 41 which is derived from the second silicon layer as shown in FIG. 16. Further, the extension direction of the electrode teeth 43a is perpendicular to the extension direction of the arm portion 32 and is parallel to the axis A3. In addition, the comb-like electrode 43A functions as a driving mechanism in cooperation with the comb-like electrode 33A. For example, when the rocking portion 30 is not operated, as shown in FIGS. 17 and 18, the comb-like electrodes 33A and 43A are positioned at different heights. Further, the electrode teeth 33a and 43a of the comb-like electrodes 33A and 43A are arranged in a staggered form so that the comb-like electrodes 33A and 43A do not contact each other in a rocking motion of the rocking portion 30.

The comb-like electrode 43B generates electrostatic attraction by cooperation with the comb-like electrode 33B. The comb-like electrode 43B includes a plurality of electrode teeth 43b which extend from the frame 41 and are spaced from each other in the extension direction of the arm portion 32. The comb-like electrode 43B is mainly derived from the second silicon layer and is fixed to the portion of the frame 41 which is derived from the second silicon layer as shown in FIG. 16. The comb-like electrode 43B, i.e., the electrode teeth 43b, is electrically connected to the comb-like electrode 43A, i.e., the electrode teeth 43a, through the portion of the frame 41 which is derived from the second silicon layer. In addition, the extension direction of the electrode teeth 43b is perpendicular to the extension direction of the arm portion 32 and is parallel to the axis A3. The comb-like electrode 43B functions as a driving mechanism in cooperation with the comb-like electrode 33B. For example, when the rocking portion 30 is not operated, as shown in FIG. 18, the comb-like electrodes 33B and 43B are positioned at different heights. Therefore, the electrode teeth 33b and 43b of the comb-like electrodes 33B and 43B are arranged in a staggered form so that the comb-like electrodes 33B and 43B do not contact each other in a rocking motion of the rocking portion 10.

In the micro rocking device X3, a predetermined potential is applied to the comb-like electrodes 33A, 33B, 43A, and 43B according to the demand to cause rotational displacement. In the micro rocking device X3, the rocking portion 30 or the mirror support portion 31 is rotationally displaced around the axis A3. The application of the predetermined potential to the comb-like electrodes 33A and 33B can be realized through the portion of the frame 41 which is derived from the first silicon layer, the torsion bars 42a, and the arm portion 32. The comb-like electrodes 33A and 33B are, for example, grounded. The application of the predetermined potential to the comb-like electrodes 43A and 43B can be realized through the portion of the frame 41 which is derived from the second silicon layer. The insulating layer is interposed between the portion derived from the first silicon layer and the portion derived from the second silicon layer in the frame 41, and thus the portions derived from the first silicon layer and the second silicon layer are electrically separated.

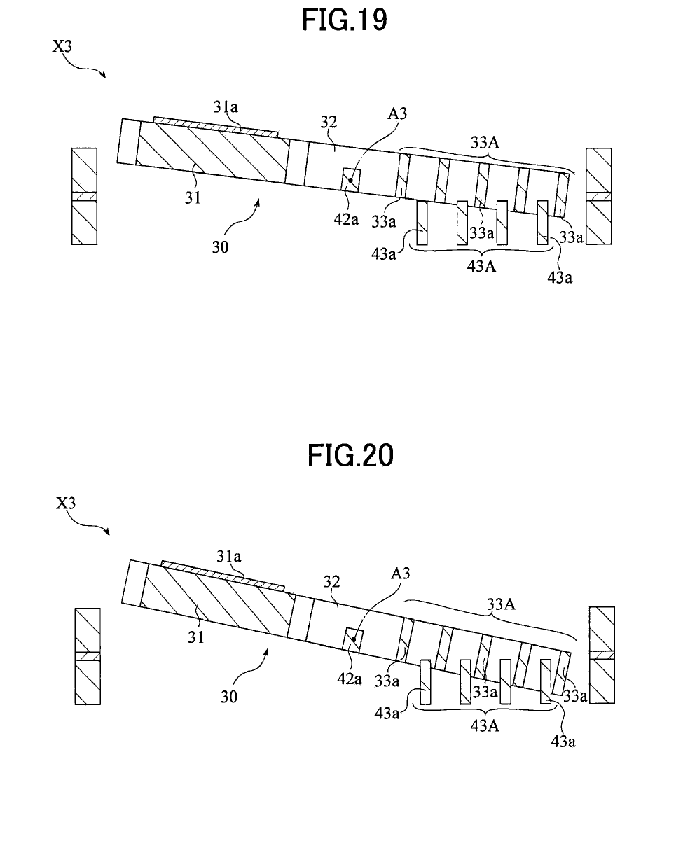

When the predetermined potential is applied to each of the comb-like electrodes 33A, 33B, 43A, and 43B to produce the desired electrostatic attraction between the comb-like electrodes 33A and 43A and between the comb-like electrodes 33B and 43B, the comb-like electrode 33A are attracted to the comb-like electrode 43A, and the comb-like electrode 33B are attracted to the comb-like electrode 43B. Therefore, the rocking portion 30 or the mirror support portion 31 makes a rocking motion around the axis A3 and is rotationally displaced to an angle at which the electrostatic attraction is balanced with the total torsion resistance of the torsion bars 42a. In the balanced state, the comb-like electrodes 33A and 43A are oriented as shown in FIG. 19, and the comb-like electrodes 33B and 43B are also oriented as shown in FIG. 19. In addition, when the electrostatic attraction between the comb-like electrodes 33A and 43A and the electrostatic attraction between the comb-like electrodes 33B and 43B are disappeared, each of the torsion bars 42a returns to its natural state, and the rocking portion 30 or the mirror support portion 31 is oriented as shown in FIG. 17. Therefore, the reflection direction of light reflected by the mirror surface 31a provided on the mirror support portion 31 can be appropriately changed by the rocking drive of the rocking portion 30 or the mirror support portion 31.

However, in the micro rocking device X3, as shown in FIG. 20, sticking easily occurs between the comb-like electrodes 33A and 43A. When the rocking portion 30 is rotationally displaced, the larger the distance from the axis A3 of the rocking portion is, the more deeply the electrode teeth 33a enter between the electrode teeth 43a of the second comb-like electrode 43A. The distance between the adjacent electrode teeth 33a and 43a becomes smaller on the axis side as the distance from the axis A3 of the rocking portion increases. In the device, the distance between the adjacent electrode teeth 33a and 43a is relatively small. Therefore, a so-called pull-in phenomenon easily occurs between the adjacent electrode teeth 33a and 43a. Therefore, sticking easily occurs between the comb-like electrodes 33A and 43A or between the electrode teeth 33a and 43a. Similarly, in the micro rocking device X3, sticking easily occurs between the comb-like electrodes 33B and 43B or between the electrode teeth 33b and 43b. When sticking occurs between the comb-like electrodes 33A and 43A and between the comb-like electrodes 33B and 43B, the rocking portion 30 is fixed to the frame 41 through the comb-like electrodes 43A and 43B, thereby failing to cause a rocking operation of the rocking portion 30.

In the embodiments, it is possible to avoid the sticking which occurs between a pair of driving comb-like electrodes in the comparative example.

1. A micro rocking device comprising:
a frame;
a rocking portion including a first comb-like electrode;
a torsion connecting portion connecting the frame and the rocking portion and defining the axis of rotational displacement of the rocking portion; and
a second comb-like electrode attracting the first comb-like electrode and rotationally displacing the rocking portion,
wherein the first comb-like electrode has a plurality of first parallel electrode teeth extending in the direction of the axis and are spaced from each other in a direction crossing the extension direction;
the second comb-like electrode has a plurality of second parallel electrode teeth extending in the direction of the axis and are spaced from each other in a direction crossing the extension direction;
each of the second electrode teeth has a first side surface on the axis side and a second side surface opposite to the first side surface; and
the second side surface has a taper region on the side opposite to the first electrode teeth, the taper region being inclined closer to the axis in a direction away from the first electrode teeth.

2. The micro rocking device according to claim 1, wherein the first side surface has a taper region on the side opposite to the first electrode teeth, the taper region being inclined away from the axis in a direction away from the first electrode teeth.

3. The micro rocking device according to claim 1, wherein the extension direction of the plurality of first electrode teeth is parallel to the axis.

4. The micro rocking device according to claim 3, wherein the extension direction of the plurality of second electrode teeth is parallel to the extension direction of the first electrode teeth.

5. The micro rocking device claim 1, wherein at least one of the first electrode teeth and the second electrode teeth each have a portion coated with a dielectric thin film.

6. The micro rocking device according to claim 5, wherein the dielectric thin film is a parylene film or a HMDS self-organizing monomolecular film.

7. A method for manufacturing the micro rocking device according to claim 1 by processing a material substrate having a laminated structure which includes a first layer, a second layer, and an intermediate layer provided between the first and second layers, the method comprising:
a step of forming on the second layer a mask pattern including a second electrode teeth mask region having a mask pattern corresponding to the second electrode teeth of the second comb-like electrode; and
a step of anisotropically dry-etching the second layer using the mask pattern;
wherein the second electrode teeth mask region has a taper surface for forming the second side surface of each of the second electrode teeth.

8. A method for manufacturing the micro rocking device according to claim 1 by processing a material substrate having a laminated structure which includes a first layer, a second layer, and an intermediate layer provided between the first and second layers, the method comprising:
a step of forming on the second layer a mask pattern including a second electrode teeth mask region having a mask pattern corresponding to the second electrode teeth of the second comb-like electrode; and
a step of anisotropically dry-etching the second layer using the mask pattern;
wherein in the etching step, a cycle etching process is executed by alternately repeating etching with an etching gas and side wall protection with a protective gas, and the time of etching with the etching gas is extended during the cycle etching process.

9. A method for manufacturing the micro rocking device according to claim 1 by processing a material substrate having a laminated structure which includes a first layer, a second layer, and an intermediate layer provided between the first and second layers, the method comprising:
a step of forming on the second layer a mask pattern including a second electrode teeth mask region having a mask pattern corresponding to the second electrode teeth of the second comb-like electrode; and
a step of anisotropically dry-etching the second layer using the mask pattern;
wherein the etching pressure is reduced during the etching step.
